(19) United States
(12) Patent Application Publication
(10) Pub. No.: US 2020/0240445 A1
(43) Pub. Date: Jul. 30, 2020

(54) Electrohydraulic System with a Hydraulic Spindle and at least One Closed Hydraulic Circuit

(71) Applicant: Robert Bosch GmbH, Stuttgart (DE)

(72) Inventors: Stefan Schober, Linz (AT); Gottfried Hendrix, Gemuenden (DE)

(21) Appl. No.: 16/652,954

(22) PCT Filed: Oct. 5, 2018
(86) PCT No.: PCT/EP2018/077145

§ 371 Date: Apr. 1, 2020

(30) Foreign Application Priority Data
Oct. 11, 2017 (DE) 10 2017 218 157.5
Oct. 25, 2017 (DE) 10 2017 219 084.1

(51) Int. Cl. F15B 21/044; B01D 19/00; F15B 1/26; F15B 11/036

(52) U.S. Cl. CPC F15B 21/044; B01D 19/0036; F15B 21/047; F15B 1/265; F15B 11/036; B01D 19/0063

(57) ABSTRACT

An electrohydraulic system includes a hydraulic load and at least one closed hydraulic circuit. The hydraulic circuit includes at least one control mechanism, a hydraulic machine, and a closed hydraulic reservoir. The closed hydraulic circuit is filled with degassed hydraulic fluid. A method, in one embodiment, includes filling the electrohydraulic system with degassed hydraulic fluid. In one embodiment, equipment is provided for filling the electrohydraulic system with the degassed hydraulic fluid

The invention relates to an electrohydraulic system having a hydraulically actuable axle and at least one closed hydraulic circuit, comprising hydraulic control means which are connected in the closed hydraulic circuit to a hydraulic machine, to a hydraulic consumer and to a hydraulic reservoir.

Electrohydraulic systems of this kind having a hydraulic axle can be used in a whole host of industrial automation applications, for example in presses, plastics machines, bending machines.

Hydraulic arrangements of this kind are also preferably used to move an element or replenish a system with fluid or change the fluid under water at water depths of up to several thousand meters in connection with the conveyance of crude oil and natural gas, in mining, scientific exploration or infrastructure projects. Hence, for example, process valves by means of which the volumetric flow of the medium being conveyed can be regulated or shut off are located at great depths in the case of offshore conveying facilities for crude oil or natural gas.

A hydraulic arrangement having an electrohydraulic actuating drive for underwater use may comprise a container, in the interior of which a hydrostatic machine that can at least be operated as a pump and an electric machine mechanically coupled with the hydrostatic machine are arranged. The main drive of the actuating drive in this case takes place via an electric motor which drives the pump and thereby adjusts a hydraulic cylinder with a rectilinear movement. The actuating drive adjusts large production fittings of oil or gas wells, for example, which regulate the delivery rate. The inside of the container is filled with a hydraulic pressure fluid, for example an oil, as the working medium. The container is closed off from the surrounding seawater region and is pressure-compensated in respect of the ambient pressure prevailing underwater. The electrohydraulic system comprises a hydraulic cylinder, the cylinder housing whereof sits on the housing of a process valve, and which comprises a piston and a piston rod projecting away from the piston on one side, via which a process valve slide of the process valve can be moved. The piston divides the inside of the cylinder housing into a cylinder space remote from the piston rod side and a cylinder space on the piston rod side. A mechanical spring arrangement, for example a helical compression spring which acts on the piston as a closing process valve, is housed in the cylinder space on the piston rod side. During the retraction and extension of a differential cylinder of this kind, oil corresponding to the volume of the cylinder rod is normally displaced or required. One disadvantage of this arrangement is that the large quantity of pressure fluid in the inside of the container can be subject to leakage losses which must be compensated. Moreover, a large amount of pressure fluid most be held ready for compression of the hydraulic cylinder. A final inconvenience is that each machine cycle also forms a stress cycle in relation to the membrane of a pressure compensator, which substantially compromises the service life for long-term underwater applications.

On this basis, the problem addressed by the present invention is that of creating an electrohydraulic system and a method which alleviate, or even avoid, the aforementioned disadvantages. In particular, the amount of pressure fluid for the hydraulic consumer is to be reduced in a structurally simple manner and the smallest possible pendulum volume produced in the container of the actuating drive. Furthermore, the service life is to be significantly improved.

These problems are solved with an electrohydraulic system and with a method according to the independent patent claims. Further embodiments of the invention are specified in the dependent patent claims. It should be pointed out that the description, particularly in connection with the figures, provides further details and developments of the invention which can be combined with the features from the patent claims.

For this purpose, an electrohydraulic system having a hydraulic consumer and at least one closed hydraulic circuit is provided, wherein the hydraulic circuit comprises at least one control means, a hydraulic machine and a closed hydraulic reservoir. The closed hydraulic circuit in this case is filled with degassed hydraulic fluid.

A hydraulic consumer may, for example, be a movable (actuating) axle, a drive, a valve slide or the like. A hydraulically actuable (actuating) axle is understood, in particular, to mean a hydraulic actuator, for example a hydraulic cylinder and the hydraulic or electrohydraulic control arrangement or circuit controlling the actuator with fluid. Hydraulic axles of this kind are compact and high-performance drives. These can be used in a whole host of industrial automation applications.

Closed hydraulic circuits can be operated with volume flow sources (hydraulic pumps). Closed hydraulic circuits generally require systems with hydraulic motors in which the returning volume flow is equal to the forward volume flow. These are working cylinders with piston surfaces or rotation motors with a rotating output drive movement. The pressure fluid remains in the hydraulic circuit. The hydraulic control means comprise hydraulic valves in particular. The hydraulic machine (fluid flow generator) is, in particular, a hydraulic pump. The hydraulic reservoir may be a hydraulic accumulator, a refilling station, a closed fluid container or the like. The hydraulic reservoir may also be formed by the internal spaces of the hydraulic circuit which substantially comprise the hydraulic machine, the hydraulic motor and/or the hydraulic outputs. The closed hydraulic circuit in this case (insofar as technically feasible) is completely filled with (a single) hydraulic fluid. For this purpose, the hydraulic circuit may even be flushed with this hydraulic fluid or aspirated beforehand using a vacuum pump, so that air bubbles (previously located) therein are largely or completely removed.

A (liquid) hydraulic fluid can be regarded as “degassed” when there is scarcely any, or no, air left in the liquid. The remaining fraction of air in a mineral oil can thereby be limited to a maximum of 8% or 9%, for example. In addition, measures and/or liquids can be used so that, in the degassed state, the free air fraction or residual gas content can even drop to 2.0% or even to 0%. The partial pressure in the fluid can be measured as an indicator of the air fraction or air content of the fluid. For example, the partial pressure in the case of a hydraulic fluid HLP 46 is lowered to a level of 0 mbar [millibar] to max 180 mbar. The particular partial pressure to be set is determined empirically by specific application and moves in this range. The partial pressure can be measured at a reference fluid temperature of 50° C., for example, or at a room temperature of 20° C.

The proposed electrohydraulic system is particularly set up to operate underwater at great depths. According to the arrangement proposed here, a hydraulic axle for use underwater or in deep seas or another closed hydraulic compact axle, e.g. a servo-hydraulic axle, is filled with degassed oil. This measure reduces the compression volume (in other words, the “depletion” of oil when the oil is exposed to atmospheric pressure by a pressure compensator in subsea applications) and leads to smaller compensators and to a smaller oil volume being held ready for compression. Quite generally, the smaller fraction of dissolved oxygen reduces the oxidation of the oil and of the hydraulic component, there is less cavitation or a diesel effect in which oil vapor dissolved in an air bubble is ignited. This means that the need for maintenance or an oil change is substantially reduced overall in tightly sealed hydraulic systems.

When it comes to the filling of closed systems in underwater hydraulic systems, the compression module of the operating medium is determinative of the size of the pressure equalization system. In the case of a degassed operating medium, the compression module of the operating medium can be particularly advantageously increased in total, so that a smaller design of the pressure equalization system is possible. At the same time, the oxidation tendency, cavitation tendency and the risk of diesel effects are reduced. Furthermore, better control is possible since the higher and virtually linear compression module of the oil column has a positive effect on the control action.

In particular, a residual gas content of the degassed hydraulic fluid is 10% at most. In other words, this means that a gas or air fraction in the hydraulic fluid is limited to a maximum of 10%.

In the case of a dynamic, hydraulically actuable axle, a residual gas content of the degassed hydraulic fluid may fall within the range of 7% to 9%. In the case of a dynamic axle, frequent and/or rapid movements of the axle are carried out, for example with a fluid column acceleration (particularly in the case of oil) of at least 20 m/s² [meter per second squared] and/or a pressure increase speed of at least 1000 bar/s [bar per second]. The aforementioned range is advantageous in the case of dynamic axles because it leads to the reduction of unwanted cavitation and/or erosion phenomena, for example in the region of the control means or control block. In the case of high dynamics, water present in the hydraulic fluid can evaporate, which can likewise lead to unwanted cavitation and/or erosion phenomena, wherein the effect can be partially alleviated by the correspondingly degassed hydraulic fluid.

A residual gas content of the degassed hydraulic fluid advantageously falls within the range of 2% to 5% in the case of a static hydraulic axle. In the case of a static axle, infrequent and/or slow movements of the axle are carried out, for example with a fluid column acceleration (particularly in the case of oil) of less than 20 m/s² [meter per second squared] and/or a pressure increase speed of less than 1000 bar/s [bar per second]. Since no water evaporation is to be expected in this case, the air fraction can be reduced further or maximally, so that the aforementioned properties of the low oxidation capacity (ageing) and/or compressibility can be further exhausted.

According to a further aspect, the use of degassed oil as a hydraulic fluid for an electrohydraulic system takes place with a hydraulic consumer and a closed hydraulic circuit, wherein the hydraulic circuit comprises at least one control means, a hydraulic machine and a closed hydraulic reservoir. The electrohydraulic system is preferably one for underwater operation at external ambient pressures above 100 bar or even above 250 bar. In the case of an underwater arrangement and in order to control a conveyable volume flow of a gaseous or liquid medium, a process valve is preferably present. The process valve may be adjusted linearly or rotatably. A hydraulic cylinder or a rotatable hydraulic motor can be used for this purpose.

According to yet another aspect, a method for setting up an electrohydraulic system having a hydraulic consumer and a closed hydraulic circuit is proposed, wherein the hydraulic circuit comprises at least one control means, a hydraulic machine and a closed-off hydraulic reservoir, comprising at least the following steps:

a) evacuation of the hydraulic circuit

b) filling of the closed hydraulic circuit with degassed hydraulic fluid.

Before the first fill or refilling of the hydraulic circuit, the closed part of the hydraulic system can be evacuated according to step a) by means of a vacuum arrangement (e.g. a vacuum pump), so that there is no, or very little, air if possible in the system. The hydraulic circuit prepared in this manner is filled with the degassed hydraulic fluid in accordance with step b), for example by means of a pipe/hose connection, so that the aforementioned filling levels can be reached.

The degassed hydraulic fluid can be introduced into the hydraulic circuit by means of excess pressure in step b).

In an additional step c), the hydraulic fluid is preferably degassed. In preparation, the oxygen fraction or air fraction in the hydraulic fluid being introduced is reduced. An oxygen content in the medium is preferably reduced to such an extent that there is no longer any free oxygen/air in the medium. For example, this point lies at around 8.5 to 9% in the case of a petroleum ISO VG46, wherein the oxygen content (residual gas content) may preferably also be less than 8.5%, depending on the plant design. A residual oxygen content of the hydraulic fluid of less than 8.5% is preferably advantageous for the refilling of systems, which corresponds to a partial pressure of less than 180 mbar in the liquid, for example.

In particular, step c) should be carried out before step b) and may overlap with step a), at least temporarily. In particular, a vacuumizing arrangement can act on the hydraulic circuit and/or a hydraulic fluid accumulator where necessary. The hydraulic accumulator may interact with the vacuumizing arrangement in such a manner that it sets a pressure above the (initially non-degassed) hydraulic fluid of an absolute 0.2 bar, for example. This leads to the foaming of the hydraulic fluid, which is caused by a greater bubble formation in the absorbed air and outgassing upwards. In this way, this absorbed air can be removed from the hydraulic fluid (degassing). A circulating pump can be provided for support which circulates the hydraulic fluid in the hydraulic fluid accumulator in a vacuum, thereby leading to improved or more uniform degassing. This circulating action can be further used to filter and/or clean the hydraulic fluid during degassing.

If the hydraulic fluid is degassed and the hydraulic circuit is vacuumized, the vacuum in the hydraulic fluid accumulator may be reduced, for example (to atmospheric pressure or above), as a result of which the degassed hydraulic fluid can be quickly drawn in, supported by the vacuum which still exists in the hydraulic circuit, and can completely fill the hydraulic circuit (insofar as possible).

Furthermore, an apparatus for setting up an electrohydraulic system is proposed which is designed with a hydraulic consumer and a closed hydraulic circuit, wherein the hydraulic circuit comprises at least one control means, a hydraulic machine and a closed-off hydraulic reservoir. The apparatus comprises at least the following:
a fluid inlet on the hydraulic reservoir,
a vacuumizing arrangement which can act on the hydraulic circuit,
a device for providing degassed hydraulic fluid which comprises at least one vacuumizing arrangement which can act on a separate hydraulic fluid accumulator and a fluid outlet for degassed hydraulic fluid from the hydraulic fluid accumulator.

The apparatus may, in particular, be configured in such a manner that the device for supplying degassed hydraulic fluid can be temporarily coupled with the electrohydraulic system, in particular via the fluid inlet or fluid outlet and/or a connection of the vacuumizing arrangement. The device for supplying degassed hydraulic fluid is, in particular, mobile or separately movable and can be attached to different electrohydraulic systems. The setting-up of an electrohydraulic system in this case particularly includes the filling of the hydraulic circuit with an operating medium, namely the degassed hydraulic fluid or degassed oil.

The separate hydraulic fluid accumulator may be configured in the manner of a tank in which the hydraulic fluid is stored, for example also at least partially under atmospheric pressure. Before the filling process, a negative pressure or vacuum (approx. 0.2 bar) can be applied to it by means of the vacuumizing arrangement, so that the stored hydraulic fluid is degassed. When the desired degassing state is reached, the degassed hydraulic fluid can be transferred from the fluid outlet of the hydraulic fluid accumulator via the fluid inlet on the hydraulic reservoir into the hydraulic circuit. This can be achieved by reducing or eliminating the vacuum in the hydraulic fluid store after connecting the fluid outlet and fluid inlet.

It is possible that the vacuumizing arrangement of the device for providing degassed hydraulic fluid can also be coupled with the hydraulic circuit. In this way, the vacuumizing arrangement can also be used or employed to evacuate the hydraulic circuit.

The device for providing degassed hydraulic fluid may be designed with a circulating pump for the separate hydraulic fluid accumulator which can realize a circular conveyance of the hydraulic fluid, possibly through at least one filter.

The comments relating to the electrohydraulic system, the use of degassed oil as a hydraulic fluid, the method for setting up an electrohydraulic system and the apparatus for setting up an electrohydraulic system can be used reciprocally for further characterization.

The invention and the technical environment are explained in greater detail below with the help of figures. In these, the same components are identified using the same reference numbers. The illustrations are schematic and are not provided to depict relative sizes. The comments made with reference to individual details of one figure can be extracted and freely combined with features of other figures or the foregoing description, unless something compellingly different emerges for a person skilled in the art or a combination of this kind is explicitly prohibited here. The drawing shows schematically:

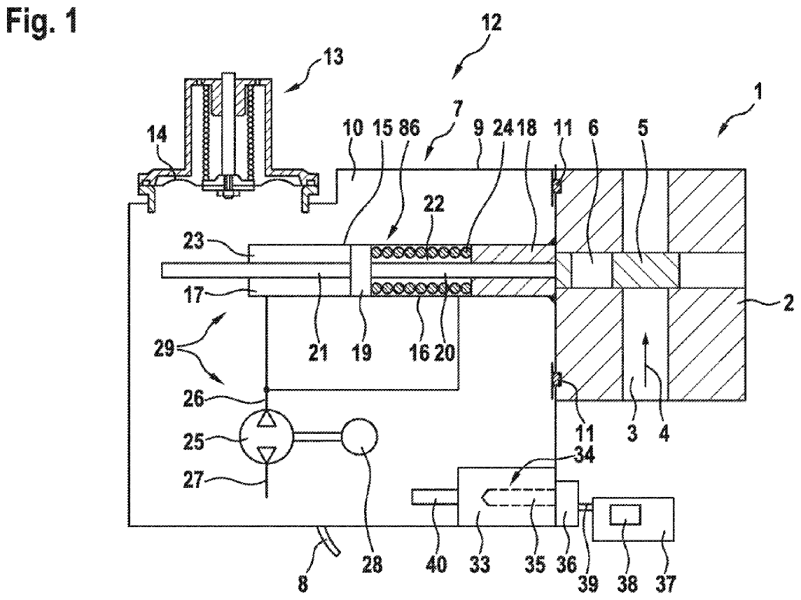

FIG. 1: a side view of the electrohydraulic system with a hydraulic axle and a closed hydraulic circuit with the process valve closed;

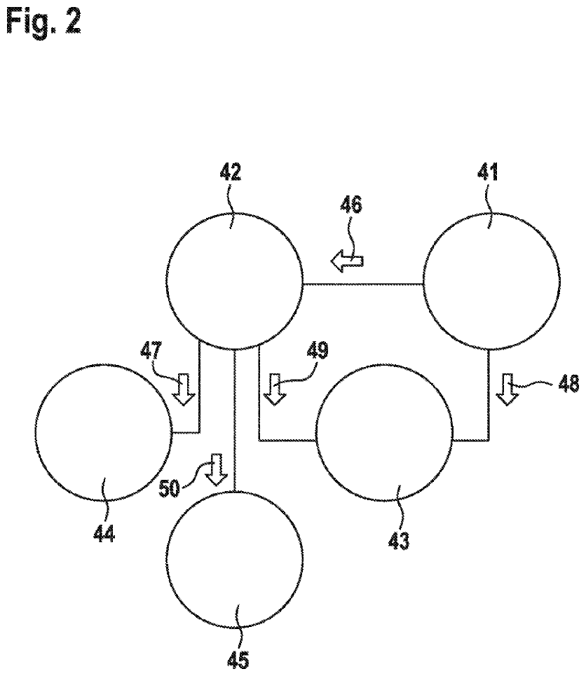

FIG. 2: a block diagram with a device for evacuating and filling a closed hydraulic circuit with degassed hydraulic fluid and flow directions of fluids;

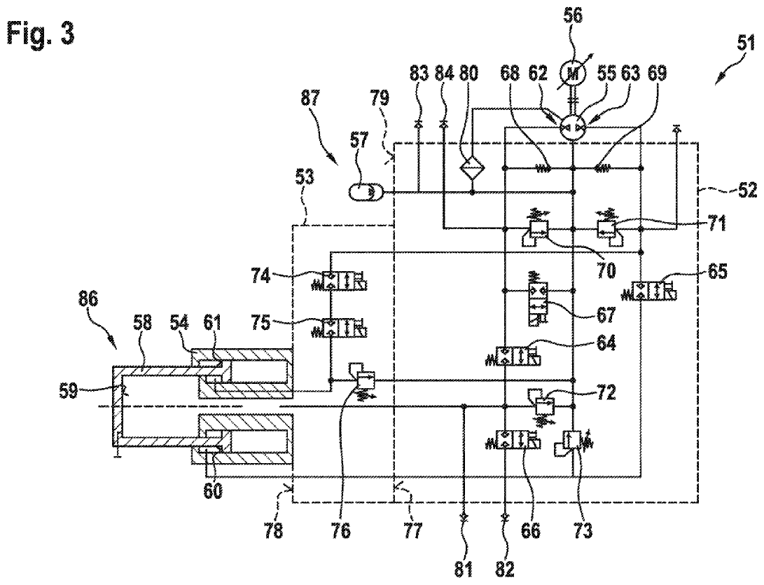

FIG. 3: a circuit diagram of a hydraulic axle with a hydraulic circuit for a closed hydraulic circuit and

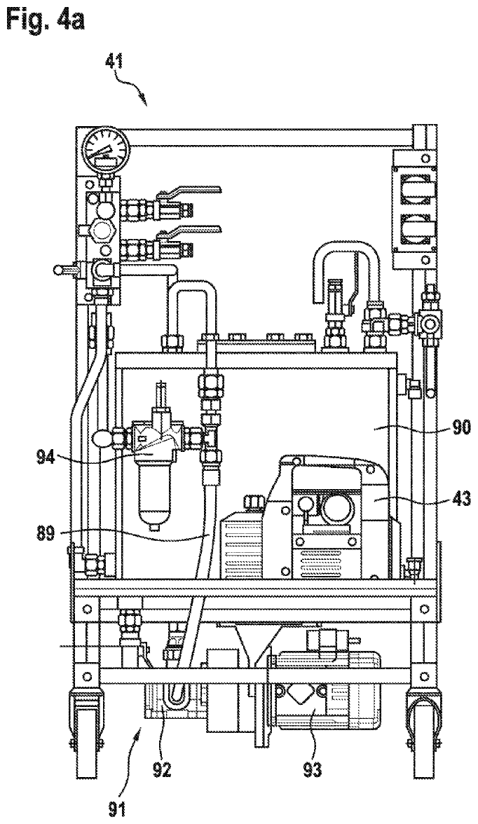

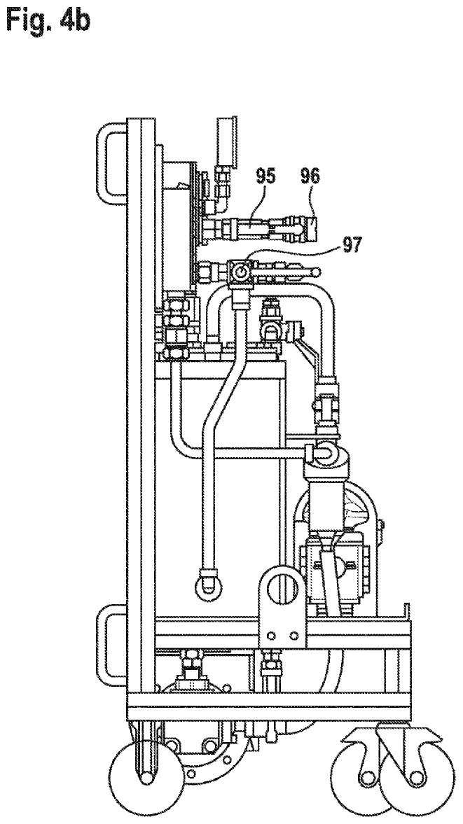

FIG. 4a, 4b: a front view (FIG. 4a) and a side view (FIG. 4b) of a device for degassing a hydraulic fluid and for filling a closed hydraulic circuit.

FIG. 1 shows an electrohydraulic system 7 with a hydraulic axle as the hydraulic consumer and a closed hydraulic circuit with the process valve 1 closed.

FIG. 1 shows an electrohydraulic actuating drive 29 for a process valve 1 having a process valve housing 2 through which a process valve channel 3 passes, which is continued at its outlets by pipes which are not shown, and in which a gaseous or liquid medium flows from the sea bed to part of a drilling rig projecting from the sea or to a drilling vessel. The flow direction is indicated by arrow 4.

A cavity is formed in the process valve housing 2 which crosses the process valve channel 3 and in which a process valve slide 5 with a discharge opening 6 can be moved transversely to the longitudinal direction of the process valve channel 3. In the state according to FIG. 1, the process valve channel 3 and the discharge opening 6 do not overlap in the process valve slide 5. The process valve 1 is therefore closed. In a state (not shown) the discharge opening 6 and the process valve channel 3 largely overlap. The process valve 1 is almost closed.

A process valve 1 of the kind shown and the use described is intended, on the one hand, to be capable of being actuated in a controlled manner and, on the other, also to contribute to safety, in that it adopts a position which corresponds to a safe state quickly and reliably in the event of a fault. In the present case, this safe state is a closed process valve 1.

The process valve 1 is actuated by a compact electrohydraulic system 7 which is arranged underwater right on the process valve 1. The hydraulic system 7 has a container 9 which is fastened to the process valve 1 on an open side, so that there is an interior 10 which is closed off from the environment and which is filled with a hydraulic pressure fluid, for example oil, as the working medium. For fastening to the process valve housing 2, the container 9 has on its open side an inner flange by means of which it is screwed to the process valve housing 2. A continuous seal 11 which is inserted into a circumferential groove in the process valve housing 2 is arranged radially outside the screw connections between the inner flange of the container 9 and the process valve housing 2.

The container 9 is pressure-compensated in respect of the ambient pressure prevailing underwater (seawater region 12). For this purpose, a membrane 14 is tightly clamped in an opening in the container wall in the case of a pressure compensator 13. The membrane 14 means that the interior 10 is partitioned off from the environment. A cable 8 is conducted out of the container 9.

In the interior 10 of the container 9, there is a hydraulic cylinder 15 (as a hydraulic consumer or actuating axle) with a cylinder housing 16 which is closed on the end face by a cylinder base 17 and a cylinder head 18, with a piston 19 that can be displaced inside the cylinder housing 16 in the longitudinal direction of the cylinder housing 16 and with a first piston rod 20 fixedly connected to the piston 19 and projects away from the piston 19 on one side, which piston rod 20 passes through the cylinder head 18 in a sealed and guided manner not depicted in greater detail. The gap between the piston rod 20 and the cylinder head 18 is sealed off by two seals (not shown) arranged in the cylinder head 18 at an axial distance from one another. The process valve slide 5 is fastened to the free end of the piston rod 20. Furthermore, there is a second piston rod 21 which is fixedly connected to the piston 19 and projects away from the piston 19 on the other side and which is guided in a sealed manner and passes through the cylinder base 17. The piston 19 divides the inside of the cylinder housing 16 into a first cylinder chamber 22 on the cylinder head side and a second cylinder chamber 23 on the base side, the volume of which second cylinder chamber depends on the position of the piston 19.

A helical compression spring 24 is housed in the cylinder chamber 22 and surrounds the piston rod 20 and is clamped between the cylinder head 18 and the piston 19, acts upon the piston 19 in a direction in which the piston rod 20 is retracted and the valve slide 5 is moved to close the process valve 1.

In the interior 10 of the container 9 is also located a hydraulic machine 25 which can be operated as a pump with two delivery directions. The hydraulic machine 25 has a pressure connection 26 and a suction connection 27 which is open to the inside 10. When operating as a pump, the hydraulic machine 25 can convey hydraulic fluid drawn from the interior 10 via the pressure connection 26 to the cylinder chamber 23. Conversely, hydraulic fluid can be displaced from the cylinder chamber 23 via the hydraulic machine 25 into the interior 10 of the container 9. An electrical machine 28 for a joint rotational movement is mechanically coupled with the hydraulic machine 25, for example via an axle.

Furthermore, a hydraulic coupling is present by means of which hydraulic fluid or oil degassed under water can be introduced from a first system (e.g. accumulator or refilling station or emergency actuation robot) into a second system (closed hydraulic circuit) without there being any contamination with seawater.

The hydraulic coupling comprises a block 33 and a hot stab (34). The block 33 is arranged in the interior 10 of the container 9, while in the example shown a stab-shaped filling part 35 is located within the block 33 and a connection part 36 outside the block 33. A remote-controlled underwater vehicle 37 which incorporates a storage container 38 for degassed hydraulic fluid or oil as the hydraulic reservoir is connected to the connection part 33. A regulating device for the oil flow from the underwater vehicle 37 to the coupling is identified as 39. The regulating device 39 comprises, or is connected to, a switch-on and switch-off device for the flow of degassed fluid from the storage container 38. An outlet region is identified as 40.

The underwater vehicle 37 may be configured as a Remote Operated Vehicle (ROV), an Autonomous Underwater Vehicle (AUV) or a Subsea Crawler (e.g. mining or cable-laying).

A (hydraulic) arrangement of the kind presented here can be installed in a new (hydraulic) device or retrofitted in an existing (hydraulic) device.

FIG. 2 shows a block diagram with an apparatus for setting up an electrohydraulic system. A device 41 for providing degassed hydraulic fluid is connected to a vacuum pump or vacuumizing arrangement 43 which is used to degas the hydraulic fluid. In addition, the hydraulic circuit 42 is optionally connected to the same vacuum pump or vacuumizing arrangement 43 which can be used to evacuate the hydraulic circuit 42. Two separate vacuum pumps (not shown) may also each be attached to the device and to the closed hydraulic circuit 42. Furthermore, an emptying device 44 is connected to the hydraulic circuit 42 which is used to empty used oil. In addition, a venting device 45 may be attached to the hydraulic circuit 42. The arrows 46 and 47 each designate a hydraulic fluid flow and arrows 48, 49, 50 each denote an air flow. The arrow tips each indicate the flow direction.

FIG. 3 shows a circuit diagram of a hydraulic axle 51 with a hydraulic circuit for a closed hydraulic circuit. A compact axle is depicted in FIG. 3. In this case, a hydraulic pump, an electric motor and a multi-face cylinder are assembled to form a structural unit. In order to control the multi-face cylinder, a plurality of control valves is provided in the control block.

The hydraulic axle 51 (servo-hydraulic compact axle) has a control block 52 to which a hydraulic cylinder 54 is attached via an intermediate block 53. A hydraulic machine 55 is furthermore connected to the control block 52 which can be used in both directions as a hydraulic pump and hydraulic motor. The hydraulic machine 55 can be driven via a drive in the form of an electric motor 56. Furthermore, a hydraulic accumulator 57 is connected to the control block 52.

The hydraulic cylinder 54 is a multi-face cylinder, the piston 58 of which has an extension surface 59, a first retraction surface 60 and a second retraction surface 61. Via the control block 52 and the intermediate block 53, the piston 58 can be extended and retracted in speed mode and in power mode. Furthermore, decompression can take place following the power mode in an extending and retracting direction. Furthermore, the piston 48 can be clamped in a pressure retention phase. Moreover, an accumulator loading mode may be provided.

The hydraulic machine 55 is connected to the control block 2 via a first pump connection 62 and a second pump connection 61. The first pump connection 62 can be fluidically connected via a first control valve 64 of the control block 52 to the extension surface 59. The first control valve 64 is configured as a switching valve, wherein the valve slide thereof is acted upon with a spring force in its closing position via a valve spring and can be moved into its opening position via an electromagnetic actuator or manually. The second pump connection 63 can be fluidically connected to the second retraction surface 61 via a second control valve 65 which is configured according to the first control valve 64. Via a third control valve 66 which is configured according to the control valves 64 and 65, the extension surface 59 can be fluidically connected to the first retraction surface 60. A flow path between the first pump connection 62 and the first control valve 64 can be fluidically connected to the hydraulic accumulator 57 via a fourth control valve 64. In addition, the hydraulic accumulator 57 can be connected via a first non-return valve 60 to the first pump connection 62 and via a second non-return valve 69 to the second pump connection 63. The non-return valves 68, 69 in this case each open in a flow direction away from the hydraulic accumulator 57. Furthermore, the first pump connection 62 is connected via a pressure-limiting valve 70 and the second pump connection 63 via a pressure-limiting valve 71 to the hydraulic accumulator 57. Moreover, the extension surface 59 can likewise be fluidically connected via a pressure-limiting valve 72 and the second retraction surface 61 via a pressure-limiting valve 73 to the hydraulic accumulator 57. Two switching valves 74, 75 are arranged in series in the intermediate block 53. In this case, they are configured according to the control valves 64 to 67. Via the switching path valves 74, 75, a pressure medium connection between the second pump connection 63 and the first retraction surface 60 can be opened and closed. The pressure medium connection in this case is opened when both switching path valves 74, 75 are switched in their opening position.

If the hydraulic cylinder 54 is arranged in a suspended manner, the piston 58 can be held high when the switching path valves 74, 75 are in the closed state via the switching path valves 74, 75. Consequently, they can be used as high-retaining valves to protect an annular chamber of the hydraulic cylinder 54 which is delimited by the first retraction surface 60 and can be used as a press cylinder. The second switching path valve 75 is disposed between the switching path valve 74 and the hydraulic cylinder 54. In turn, a pressure-limiting valve 76 is connected between the first retraction surface 60 and the second switching path valve 75. Said pressure-limiting valve is arranged in the intermediate block 53 and connected to the hydraulic accumulator 57 via the control block 52.

The intermediate block 53 also has a first connection surface 77 and a second connection surface 78. In this case, the first connection surface 77 is connected to a connection surface 79 or end face of the control block 52. The hydraulic cylinder 54 is in turn connected to the second connection surface 78. The connection surfaces 77, and 79 have an identical hole pattern in this case. Consequently, the hydraulic cylinder 54 could also be directly connected to the control block 52 without an intermediate block 53.

A filter is identified as 80 and non-return valves as 81 to 84 (without pressure drop).

FIGS. 4a, 4b show schematically as a front view (FIG. 4a) and as a side view (FIG. 4b) a device 41 for providing degassed hydraulic fluid and for filling a closed hydraulic circuit 42 (see FIG. 2) with the degassed hydraulic fluid.

The degassed oil required for filling a hydraulic system can be prepared for use by means of the device 41. Evacuation of the hydraulic bores in the control block, the interiors of the superstructures and the cylinder (electrohydraulic system) is possible using the device 41. Filling with the prepared hydraulic fluid is possible thereafter. If the device 41 is connected to a hydraulic system with pressure-resistant hydraulic hoses 88 which are not shown, said system can be flushed and the hydraulic fluid in the secondary flow can be evacuated and filtered.

The volumetric flow of the installed pump (filter pump 92) is at most 7.5 l/min. The operating temperature falls within the range of +10° C. to 60° C. Pressure fluids with a viscosity of 10 to 300 m²/s are suitable.

The device 41 comprises a container or separate hydraulic fluid accumulator 90 (oil container) which is vacuum-tight and pressure-tight. A filter pump unit (or circulation pump) 91 is mounted on the lower part of the hydraulic fluid accumulator 90 and is supplied with a bypass pipe 89 of 3 bar to the hydraulic fluid accumulator 90 (tank). The filter pump unit 91 comprises an electrically operated filter pump 92, for example an internal gear pump, having an exchangeable low-pressure filter which is monitored by means of an optical maintenance display. An electric motor (“main pump” motor) is identified as 93 and a line filter as 94.

A low-pressure distributor block is provided with the filter pump unit 91 and the upper part of the hydraulic fluid accumulator 90. The distributor block carries low-pressure plug-in connections (e.g. for filling a hydraulic system) which can be connected using ball cocks and a leak-free hydraulic quick-action coupling for refilling. A movable frame carries the hydraulic fluid accumulator 90 with the filter pump unit 91 and the distributor block and a vacuum pump or vacuumizing arrangement 43. This vacuumizing arrangement 43 is connected to the upper part of the hydraulic fluid accumulator 90 via an oil separator by means of a low-pressure hose. With a 3/2-way functional ball cock 97 (3-way ball cock), the hydraulic fluid accumulator 90 can be connected to the atmosphere or to the vacuum pump or vacuumizing arrangement 43. The pressure hoses are each fitted with a hydraulic quick-action coupling at the end. A coupling sleeve (hydraulic filling) is identified as 96.

The hydraulic machine 25; 55 is shown in FIG. 1 as a hydraulic pump with two delivery directions and in FIG. 3 as a hydraulic pump and/or hydraulic motor. The hydraulic consumer 86 is shown in FIG. 1 as a double-acting hydraulic cylinder 15 with a two-sided piston rod and in FIG. 3 as a multi-face cylinder. The hydraulic reservoir 87 is shown in FIG. 1 as a container 9 and in FIG. 3 as a hydraulic accumulator 57.

1. An electrohydraulic system, comprising:
a hydraulic consumer; and
at least one closed hydraulic circuit that includes at least one control mechanism, a hydraulic machine, and a closed hydraulic reservoir,
wherein the closed hydraulic circuit is filled with degassed hydraulic fluid.

2. The electrohydraulic system according to claim 1, wherein a residual gas content of the degassed hydraulic fluid is 10% at most.

3. The electrohydraulic system according to claim 1, wherein the hydraulic consumer comprises a dynamically actuable axle and a residual gas content of the degassed hydraulic fluid falls within the range of 7% to 9%.

4. The electrohydraulic system according to claim 1, wherein the hydraulic consumer comprises a statically actuable axle and a residual gas content of the degassed hydraulic fluid falls within the range of 2% to 5%.

5. The electrohydraulic system according to claim 1, wherein degassed oil is used as the degassed hydraulic fluid.

6. A method for setting up an electrohydraulic system that includes a hydraulic consumer and a closed hydraulic circuit, the hydraulic circuit including at least one control mechanism, a hydraulic machine, and a closed-off hydraulic reservoir, the method comprising:
evacuating the hydraulic circuit; and
filling the closed hydraulic circuit with degassed hydraulic fluid.

7. The method according to claim 6, wherein filling the closed hydraulic circuit includes introducing the degassed hydraulic fluid into the hydraulic circuit by excess pressure.

8. An apparatus for setting up an electrohydraulic system that includes a hydraulic consumer and a closed hydraulic circuit, the hydraulic circuit including at least one control mechanism, a hydraulic machine, and a closed-off hydraulic reservoir, the apparatus comprising:
a fluid inlet on the hydraulic reservoir;
a vacuumizing arrangement configured to act on the hydraulic circuit; and
a device configured to provide degassed hydraulic fluid, the device including at least one vacuumizing arrangement configured to act on a separate hydraulic fluid accumulator and a fluid outlet for degassed hydraulic fluid from the hydraulic fluid accumulator.

9. The apparatus according to claim 8, wherein the vacuumizing arrangement of the device is configured to be coupled with the hydraulic circuit.

10. The apparatus according to claim 8, wherein the device is configured with a filter pump unit for the separate hydraulic fluid accumulator.
